(19) United States
(12) Patent Application Publication
(10) Pub. No.: US 2024/0247119 A1
(43) Pub. Date: Jul. 25, 2024

(54) Composite Material Layer and Manufacture of Sandwich Panels

(71) Applicant: Gurit (UK) Ltd., Isle of Wight, Hampshire (GB)

(72) Inventors: Will Travis, Isle of Wight, Hampshire (GB); Ben Creaser, Isle of Wight, Hampshire (GB)

(21) Appl. No.: 18/559,372

(22) PCT Filed: Aug. 2, 2022
(86) PCT No.: PCT/EP2022/071747

§ 371 Date: Nov. 7, 2023

(30) Foreign Application Priority Data
Aug. 2, 2021 (GB) 2111125.7
Jun. 8, 2022 (GB) 2208410.7

(51) Int. Cl. C08J 5/24; B29C 70/16; B29C 70/30; B29C 70/68; B29D 99/00; B29K 31/00; B29K 67/00; B29K 105/04; B29K 105/08; B29K 509/08; B29L 31/08; B29L 31/30; B32B 5/02; B32B 5/18; B32B 5/24

(52) U.S. Cl. CPC C08J 5/244; B29C 70/16; B29C 70/30; B29D 99/0025; B32B 5/024; B32B 5/18; B32B 5/245; B29C 70/682; B29K 2031/00; B29K 2067/003; B29K 2105/04; B29K 2105/0845; B29K 2105/0854; B29K 2105/089; B29K 2509/08; B29L 2031/085; B29L 2031/3067; B32B 2260/023; B32B 2260/046; B32B 2262/101; B32B 2266/0264; B32B 2307/718; B32B 2307/72; B32B 2307/748; C08J 2333/14

(57) ABSTRACT

A composite material layer, which is a curable resin which is in the form of a solid layer at 20° C., the composite material layer being a prepreg of at least one ply of fibrous reinforcement material at least partly impregnated by the curable resin or a film of the curable resin, wherein at least 50 wt % of the curable resin comprises at least one polymerisable vinyl ester prepolymer having at least two carbon-carbon unsaturated functional groups, the prepolymer being polymerisable by reaction of the unsaturated functional groups to form a cured resin, wherein the curable resin further is a free-radical curing system for polymerizing the polymerisable vinyl ester prepolymer.

### FIELD OF THE INVENTION

The present invention relates to a composite material layer comprising a curable resin comprising a polymerisable vinyl ester prepolymer and a method of manufacturing a composite material layer. The present invention also relates to a method of manufacturing a sandwich panel comprising layers of fibre-reinforced composite material bonded to opposite faces of a core layer using such composite material layer. In particular, the present invention relates to prepregs or resin films for manufacturing sandwich panels comprising fibre-reinforced composite materials in which a solid resin film can be used to provide a curable resin for combining with a fibrous reinforcement material, instead of the use of a liquid resin infusion process.

### BACKGROUND

It is well known in the art of manufacturing fibre-reinforced composite materials to combine a curable resin with fibrous reinforcement material in a mould prior to curing the resin. It is also well known that two alternative known processes may be used to achieve such a combination, in particular the use of prepregs or a liquid resin infusion process.

Prepregs comprise a fibrous reinforcement material which has previously been impregnated with a desired quantity of resin to provide a pre-set weight ratio between the fibres and the resin, and the resin is in a substantially solid form, and typically has been partly cured so as to be “B-staged” and thereby exhibit an increased viscosity. The prepregs are laid up in the mould, and then the resin is heated, to cause the resin to liquefy and thereby flow to wet-out the fibres, and then the resin is subsequently cured.

A liquid resin infusion process provides dry fibrous reinforcement material in the mould, and then liquid resin is introduced into the mould, typically under vacuum in a process called vacuum assisted resin transfer moulding (VARTM), to wet-out the fibres, and then the resin is subsequently cured.

These known processes may be used for manufacturing large mouldings, such as wind turbine blades and marine parts such as boat hulls.

As a general rule, for manufacturing such large mouldings, prepregs provide the advantage of increased control of the distribution of the resin as compared to a liquid resin infusion process, but have the disadvantage of increased material cost.

Historically, wind turbine blades have been manufactured using either prepregs or a liquid resin infusion process. Currently, wind turbine blade producers are increasingly moving away from the use of prepregs to the use of liquid infusion of an epoxy resin. The primary reason is cost reduction. However, liquid infusion brings several disadvantages, for example increased parasitic resin weight, undesired resin uptake by the core of the blade, and a higher risk of product or manufacturing failure.

For the manufacture of large marine parts, such as boat hulls, currently boat manufacturers typically using polyester or vinyl ester resins in wet-layup processes. However, the mechanical performance of such resins is generally low compared to the mechanical performance of epoxy resins. Also, these resins exhibit poor safety performance during fabrication, for example by emitting fumes. The alternative use of epoxy resin prepregs would increase manufacturing cost, and may require the need to procure new higher temperature tooling and oven systems.

Consequently, there is a need to provide an improved resin system for the manufacture of fibre-reinforced composite materials, in particular large parts such as wind turbine blades and marine parts such as boat hulls, which can provide the combination of ease of manufacture, low manufacturing cost with regard to materials and manufacturing apparatus, and good mechanical performance of the resultant composite material product.

As an alternative process which has nevertheless not been known for the commercial manufacture of large composite parts, the construction of composite material laminates using solid resin films layered with dry reinforcement is historically known. The resin films comprise a single component resin, known in the art as a “1K” resin. However, there is no disclosure of such resin films which can reliably be used to manufacture large composite material parts, as discussed above.

Cure inhibition/air inhibition is a well-known phenomenon in vinyl ester liquid infusion resin systems. Such inhibition conventionally presents in vinyl ester glass reinforced plastic (GRP) parts/laminates as an outermost resin layer which is acetone-sensitive and/or has a potentially tacky surface. Conventionally, this inhibition problem is overcome with use of a wax topcoat applied over the resin surface, an increase in accelerator (e.g. cobalt) level in the curing system or an increase in cure temperature. Indeed, it known in the art that curing at high temperatures, e.g. 100° C. or higher, reduces the susceptibility of the vinyl ester resin to exhibiting the problem of air inhibition. However, lower cure temperatures are desirable by the marine and wind industries, in which large size components are required to be moulded.

Sandwich-structured composites are a widely adopted class of composite materials fabricated by attaching two thin but stiff skins to a lightweight but thick core. The core material is normally a low strength material, but its higher thickness provides the sandwich composite with high bending stiffness with overall low density.

Low density cellular foams, for example composed of polyethylene terephthalate (PET) or polyvinylchloride (PVC), are commonly used core materials. Laminates of glass or carbon fibre-reinforced thermoset polymers, for example epoxy resins or vinyl ester resins, are widely used as skin materials. The core may be bonded to the skin with an adhesive; however, in film infusion or prepreg applications it is desirable for the film infusion or prepreg resin to provide adequate adhesion between the laminate and core.

In a vinyl ester film infusion process, which uses a solid layer of the vinyl ester resin, even if air-inhibition has been minimised with the use of a suitable combination of cure package and elevated cure temperature, inhibition has also been found at the interface between the fibre-reinforced resin matrix composite material (i.e. the resin-fibre laminate) and the core. This core inhibition is evidenced when the resin-fibre laminate is de-bonded from the core as a tacky surface on the resin-fibre laminate, i.e. on the core-facing side of the resin-fibre laminate, and a tacky core surface, i.e. on the laminate-facing side of the core. Such core inhibition is also evidenced following de-bonding, where the failure mode is primarily at the interface, which is exhibited by minimal core remaining bonded to the laminate after separation of the laminate from the core. In contrast, a desirable and strong bond is achieved when the failure-mode is primarily within the core, which is exhibited by the de-bonded laminate being covered in a residual portion of the bonded core.

### SUMMARY OF THE INVENTION

The present invention aims to provide a composite material layer comprising a curable resin comprising a polymerisable vinyl ester prepolymer which has particular use in the manufacture of large composite material parts and structures.

Furthermore, the present invention aims to provide a composite material layer comprising a curable resin, which comprises a polymerisable vinyl ester prepolymer, which is in the form of a solid layer at 20° C. and which can overcome the problem of core inhibition when the curable rein is bonded to a core layer during the manufacture of sandwich panels.

Still further, the present invention aims to provide a composite material layer in the form of a prepreg or a resin film comprising a curable resin, which comprises a polymerisable vinyl ester prepolymer, which is in the form of a solid layer at 20° C. and which can be used in the manufacture of large composite material parts and structures, for example sandwich panels.

The present invention also aims to provide a prepreg or a solid resin film which can provide the combination of ease of manufacture, low manufacturing cost with regard to materials and manufacturing apparatus, and good mechanical performance of the resultant composite material product, and in particular can provide improved performance as compared to the use of liquid resin infusion for the manufacture of large composite material parts and structures.

The present invention in addition aims to provide a prepreg or a solid resin film, and an associated method of manufacturing fibre-reinforced composite materials, and sandwich panels, in which the prepreg or solid resin film can be used to provide a curable resin for combining with a fibrous reinforcement material, instead of the use of a liquid resin infusion process, in particular for the manufacture of large composite material parts and structures.

The present invention additionally aims to provide a curable resin, which comprises a polymerisable vinyl ester prepolymer, which is in the form of a solid layer at 20° C. and has versatility to be used either in the form of a prepreg or in the form of a resin film, which can be used in the manufacture of large composite material parts and structures, for example sandwich panels.

In a first aspect, the present invention provides a composite material layer.

In a second aspect, the present invention provides a method of manufacturing a sandwich panel.

In a third aspect, the present invention provides a method of manufacturing a sandwich panel.

In a fourth aspect, the present invention provides a method of manufacturing a composite material layer.

The preferred embodiments of the present invention can provide a prepreg or a resin film which comprises a resin which is in the form of a solid layer at 20° C. The preferred embodiments of the present invention can also provide an associated method of manufacturing fibre-reinforced composite materials, in particular sandwich panels, which causes the resin in the prepreg or resin film to melt and flow into a layer of fibrous reinforcement material thereby to wet-out the fibres in the fibrous reinforcement material, i.e. an infusion process. When using a resin film, this embodiment can achieve the process and performance advantages of the use of prepregs but at a low material cost substantially corresponding to the cost of a liquid resin infusion process, and with the additional benefits of faster cycle times as compared to a typical liquid resin infusion process.

The present invention is predicated on the finding by the present inventors that when making a composite material layer comprising a curable resin which is in the form of a solid layer at 20° C., wherein at least 50 wt % of the curable resin comprises at least one polymerisable vinyl ester prepolymer having at least two carbon-carbon unsaturated functional groups, and the prepolymer is polymerisable by reaction of the unsaturated functional groups to form a cured resin by use of a free-radical curing system for polymerizing the polymerisable vinyl ester prepolymer, the selection of a combination of particular curing properties of the curable resin can enable the composite material layer to be manufactured in the form of a prepreg or a resin film, yet after curing enables a high-quality sandwich panel to be manufactured which exhibits strong adhesion of the resin, used in a laminate formed from the prepreg or resin film, to a core.

In particular, it has been found unexpectedly that by providing the combination of technical features that (i) the curable resin has a reaction onset temperature within the range of from 80 to 100° C., preferably from 85 to 95° C., as measured by dynamic scanning calorimetry (DSC) over a temperature range of from 25 to 260° C. at a ramp rate of 10° C./minute, and (ii) the curable resin has a gel time of from 10 to 60 minutes, measured at a temperature of 70° C., the curable resin can exhibit high adhesion strength in a sandwich panel, as determined using a climbing drum peel test, using a relatively low temperature curing process (typically applying a curing temperature of about 70-80° C.), which low temperature is required when manufacturing large structural components such as wind turbine blades and marine vessels or parts therefor, and yet the resin can form a prepreg, and can readily be impregnated into fibrous reinforcement material to form the prepreg, or can form a resin film, to form a solid resin layer.

Typically, the reaction onset temperature is within 20° C. higher than the cure temperature to be applied to the curable resin. For example, for a cure temperature of 80° C., the maximum reaction onset temperature is preferably 100° C.

Furthermore, typically, the reaction onset temperature is at least 25° C. higher than the filming or prepregging temperature used to manufacture the composite material layer. For example, for a prepregging or filming temperature within the range of 60 to 70° C., the reaction onset temperature is preferably within the range of 85 to 95° C.

In this specification the reaction onset temperature of the curable resin is measured by DSC on a freshly mixed curable resin, i.e. within 24 hours of blending the prepolymer and the cuing agent system. The reaction onset temperature would have a tendency progressively to decrease over a time period of around 1 week until substantially stabilising.

Therefore the present invention can provide a resin which can be readily employed to form a prepreg, or a resin film, each incorporating a solid resin layer, without the resin prematurely curing, but which can also be employed to make high quality sandwich panels exhibiting high laminate-core adhesion, even though the sandwich panels can be cured at relatively low temperatures, such as a within a curing temperature range of from about 70 to 80° C., which is particularly advantageous for the manufacture of large components.

For the manufacture of large marine parts, the preferred embodiments of the present invention can further provide the advantage that volume boat producers typically currently using polyester or vinyl ester wet-lay processes can readily modify the production process to achieve increased product performance with regard to mechanical properties, similar to the performance achievable by epoxy resin prepregs, but without the increase in cost or the need to procure new higher temperature tooling and oven systems that would be required with the use of conventional epoxy prepregs.

### BRIEF DESCRIPTION OF THE DRAWINGS

Embodiments of the present invention will now be described by way of example only, with reference to the accompanying drawings, in which:

FIG. 1 is a side cross-sectional view which schematically illustrates the use of a curable composite layer in the form of a resin film in accordance with an embodiment of the present invention in a method of manufacturing a fibre-reinforced composite material;

FIG. 2 is a side cross-sectional view which schematically illustrates an embodiment of the resin film of FIG. 1;

FIG. 3 is a side cross-sectional view which schematically illustrates an embodiment of a curable composite layer in the form of a prepreg in accordance with an embodiment of the present invention;

FIG. 4 is a side cross-sectional view which schematically illustrates a sandwich panel comprising outer composite material plies, formed from curable composite layers, which may be in the form of a resin film or prepreg, in accordance with any of the embodiments of the present invention, bonded to opposite faces of a central core layer;

FIG. 5 is a photograph of a sandwich panel manufactured in accordance with an embodiment of the present invention, which has been de-bonded, and exhibits high adhesion strength between the outer composite material plies and the central core layer; and

FIG. 6 is a photograph of a sandwich panel not manufactured in accordance with an embodiment of the present invention, which has been de-bonded, and exhibits low adhesion strength between the outer composite material plies and the central core layer.

### DETAILED DESCRIPTION

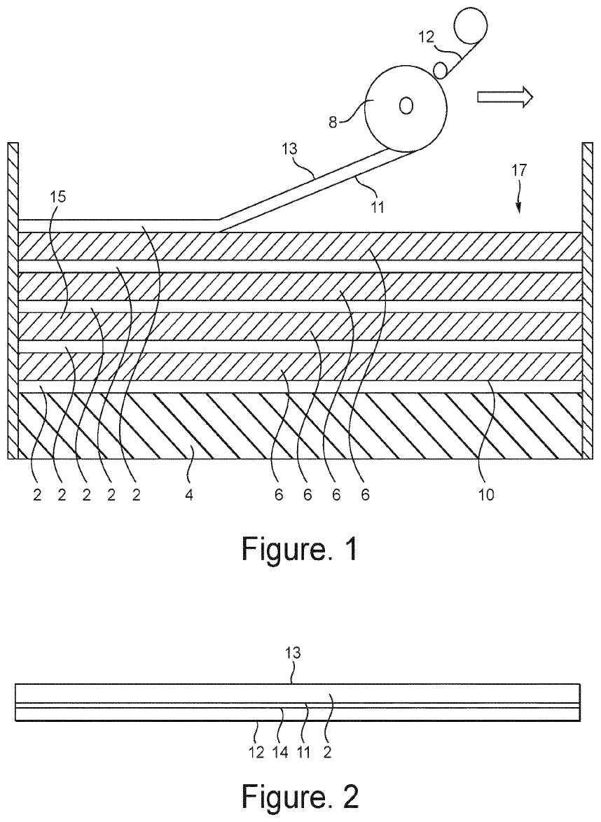

The drawings of FIGS. 1 to 4 are highly schematic and are not drawn to scale, and some dimensions are exaggerated for the sake of clarity of illustration.

Referring to FIG. 1, there is shown the use of a composite material layer comprising a resin film 2 in accordance with an embodiment of the present invention, the layer being used in a method of manufacturing a fibre-reinforced composite material. As described in detail hereinbelow, typically the resin film 2 is applied as a layer directly to the moulding surface of the required composite tool and then a layer of glass, carbon or other reinforcing fabric is applied over the resin film 2. Alternatively, the first layer deposited onto the moulding surface may be a layer of glass, carbon or other reinforcing fabric, and then the resin film 2 is applied over the glass etc layer, which may enhance the air-free quality of the resultant laminate. This layering process, which may be caried out manually or automatically by a robot, is repeated to construct a laminate of a desired thickness which is then consolidated with pressure or vacuum and cured using heat.

The alternate layering of a solid resin film 2 and fibrous reinforcing material to form an alternating laminate structure distinguishes the method of manufacturing a fibre-reinforced composite material from the use of solid prepregs and the infusion of a liquid resin, from outside the mould cavity, into a stack of dry fibrous reinforcement material.

The resin film 2 is in the form of a solid layer, which is solid at 20° C., and typically solid over a broad temperature range which includes the typical ambient or room temperature value of 20° C. and encompasses a working range for use of the resin film 2 in the manufacturing method. Typically, the resin film is solid at temperatures up to 40° C.

Typically, during the manufacturing method, after the resin film 2 has been laid-up as illustrated in FIG. 1, the resin film 2 is heated to a temperature above the melting temperature of the resin to form a liquid which then flows to wet-out the fibres of a fibrous reinforcement material. Then the resin is cured to form a cured resin matrix containing the fibrous reinforcement material. This forms a fibre-reinforced resin matrix composite material during the moulding of large composite part, for example a wind turbine blade or a marine vessel.

As shown in FIGS. 1 and 2, a mould 4 is provided. Layers of fibrous reinforcement material 6 are laid up in the mould 4. The fibrous reinforcement material 6 may be composed of any suitable fibres, for example glass fibres, carbon fibres or natural fibres such as flax fibre, which have been selected for the desired product comprised of fibre-reinforced resin matrix composite material which is to be manufactured. The fibrous reinforcement material 6 may also be in any desired form, for example a woven textile having any suitable weaving pattern, or a non-woven textile. In summary, the resin film 2 can be used with any type of fibrous reinforcement material 6 to manufacture the fibre-reinforced resin matrix composite material.

The resin film 2 is provided in the form of a wound roll 8 of an elongate length of the resin film 2. The resin film 2 is unwound from the roll 8 and laid over the surface of a layer of fibrous reinforcement material 6. The weight per unit area, and therefore the thickness, of the resin film 2 is selected to provide the desired weight ratio between the fibrous reinforcement material 6 and the cured resin in the resultant fibre-reinforced composite material.

In one embodiment, the resin film 2 is a coherent layer having first and second opposed resin surfaces 11, 13. The first and second opposed resin surfaces 11, 13 may be self-adhesive, which means that the surface have an intrinsic tack at the lay-up temperature, so that the resin adheres to the surface of the layer of fibrous reinforcement material 6. Such a resin film 2 may be provided in roll form with the successive layers of the resin film 2 in the roll 8 being in contact with each other.

As known to those skilled in the art, the degree of tack of a polymerisable resin can be controlled. Consequently, the tack may be controlled so that the roll 8 of the resin film 2 can readily be unwound.

As shown in FIG. 1, in one embodiment, the resin film 2 is temporarily supported by a release backing layer 12, for example a siliconised paper or polymer layer, and one of the opposed resin surfaces is releasably adhered to the release backing layer 12. The resin film 2 is separated from the release backing layer 12 when the roll 8 is unwound to deliver the resin film 2 into the mould 4.

In some embodiments of the present invention, the resin of the resin film 2 has sufficient intrinsic tear strength that the resin film can be completely coherent and unsupported when delivered into the mould 4. The resin film 2 is preferably formulated to have sufficient tensile strength and tear strength so as not to distort or break during the end application to manufacture the composite material part.

However, in other embodiments of the present invention, in order to increase the tear strength, a very lightweight fibrous tissue or scrim may be co-laminated into the resin film 2. The fibrous tissue or scrim can provide the desired tear strength, without reducing other material or performance properties, or significantly increasing material cost.

Accordingly, in some embodiments, as shown in detail in FIG. 2, the resin film 2 is supported on a lightweight textile sheet 14 to which one of the opposed resin surfaces 11, 13 is adhered. Optionally, the resin of the resin film 2 may completely or partially impregnate the lightweight textile sheet 14. Typically, the lightweight textile sheet 14 has an areal weight of from 1 to 75 grams per square metre (gsm), optionally from 5 to 25 grams per square metre (gsm), and a tear strength of at least 500 N/m. The tear strength may be evaluated under the protocol of ASTM D624 using the calculation tear strength=tear load/thickness, the parameters being measured under ambient conditions (i.e. at a temperature of 20° C.).

The lightweight textile sheet 14 may comprise woven or non-woven polymeric fibres, for example polyester fibres. The material and areal weight of the lightweight textile sheet 14 are typically selected so as to provide substantially no modification to the mechanical properties of the resultant fibre-reinforced composite material. The lightweight textile sheet 14 is provided to enhance the tear strength of the resin film 2. The desired tear strength depends upon the specific manufacturing application and typically the dimensions of the component or structure to be manufactured.

Therefore, the resin film 2 is positioned adjacent to the layer of fibrous reinforcement material 6 to form a laminate 10 between the resin film 2 and the layer of fibrous reinforcement material 6. After the layer of the resin film 2 has been laid over the surface of the layer of fibrous reinforcement material 6, a subsequent layer of fibrous reinforcement material 6 is laid over the resin film 2. This sequence of steps is repeated so that a laminated stack 15 of alternating plies of fibrous reinforcement material 6 and resin film 2 is built up in the mould 4 until the desired total fibre weight, with the desired proportions by weight of fibrous reinforcement material and resin, has been achieved.

Then the mould 4 is then typically closed to contain the laminated stack 15 within the mould cavity 17. Thereafter, the temperature of the laminated stack 15 is increased to an elevated temperature to cause the polymerisable resin to melt and flow into the layers of fibrous reinforcement material 6 thereby fully to wet out the fibres in the fibrous reinforcement material 6.

Subsequently, the resin thereby dispersed uniformly throughout the mould cavity 17 is subjected to a polymerizing step in which the monomer is polymerized at a curing temperature, which is at least as high as the elevated temperature to wet-out the fibres, to form a cured resin matrix containing the fibrous reinforcement material 6.

Typically, the mould 4 is heated to a first elevated temperature, and optionally held at that temperature for a dwell time period, to cause complete wet-out of the fibres in the fibrous reinforcement material by the liquefied molten resin. During or prior to the heating, the laminate is consolidated with pressure or vacuum to ensure complete wet-out of the fibres. Thereafter, the mould 4 is heated to a second elevated temperature, which is higher than the first elevated temperature, which is a curing temperature. Preferably, the polymerization step is carried out by radical curing of unsaturated functional groups in the polymerisable resin by a free-radical curing system in the initial resin film 2. Typically, a peroxide radical curing is used to cure the unsaturated functional groups in the polymerisable resin. The mould 4 is then held at the curing temperature for a sufficient curing time period, to cause complete curing of the polymerisable resin.

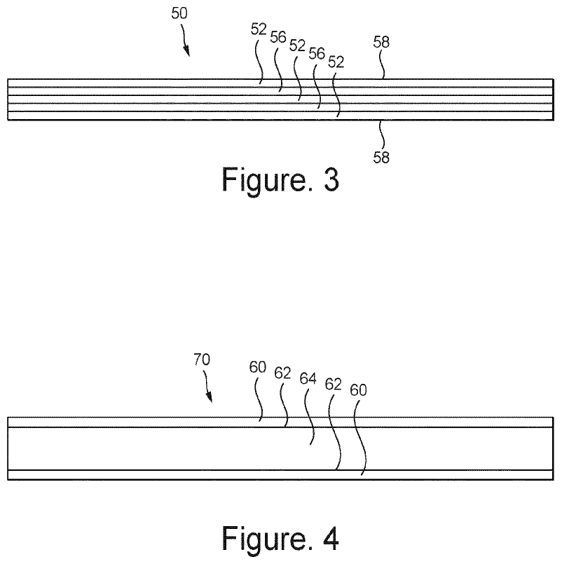

FIG. 3 illustrates a composite material layer in the form of a prepreg 50 in accordance with another embodiment of the present invention. The prepreg 50 comprises at least one ply 56 of fibrous reinforcement material which is at least partly impregnated by the curable resin of at least one ply 52 of the curable resin laminated to at least one ply 56 of fibrous reinforcement material.

The prepreg 50 may be fully impregnated, or partly impregnated (otherwise known in the art as a “semi-preg”) and when partly impregnated the prepreg structure may have a three layer laminar structure consisting of dry fibre/resin/dry fibre which structure is known in the commercial product “SPRINT®” manufactured and sold by Gurit (UK) Ltd.

Typically, an exterior surface 58 of the prepreg 50 is formed by the ply 52 of the curable resin. In the illustrated embodiment, the prepreg 50 comprises a plurality of plies 56 of fibrous reinforcement material and a plurality of plies 52 of the curable resin, and the plies 56 of fibrous reinforcement material and the plies 52 of the curable resin are laminated together in an alternating arrangement so that at least one exterior surface 58, and optionally both of the opposite exterior surfaces 58, are formed by a respective ply 52 of the curable resin.

In the prepreg 52, the curable resin typically has the same resin composition as described above for the resin film 2 described above with respect to the embodiments of FIGS. 1 and 2, and also the fibrous reinforcement material may also have the same composition as the fibrous reinforcement described above with respect to the embodiments of FIGS. 1 and 2.

The prepreg 52 may be moulded in a mould to form a fibre-reinforced resin matrix composite material as generally described above with respect to the resin film 2. A laminated stack of prepregs is laid up in a mould, and then the stack is heated to a curing temperature. The resin melts and flows to wet-out the fibrous reinforcement and then the resin is cured.

FIG. 4 illustrates a sandwich panel 70 comprising outer composite material plies 60 bonded to opposite faces 62 of a central core layer 64. The outer composite material plies 60 are formed from curable composite layers, which may be in the form of a resin film 2 in combination with additional fibrous reinforcement, as described above with reference to FIGS. 1 and 2, or in the form of a prepreg 50, as described above with reference to FIG. 3, in accordance with any of the embodiments of the present invention. Typically, during the manufacture of the sandwich panel, the curable resin is laid up directly in contact with the core layer 64. The core layer 64 may comprise a cellular polymer foam, for example composed of PET or PVC, or any other polymer known for making structural cellular foam cores. Alternatively, the core layer 64 may comprise balsa wood or a honeycomb cellular core material, which are well-known core materials for the manufacture of sandwich panels.

For manufacturing the sandwich panel 70, when the resin film 2 is used, a resin film 2 is positioned adjacent to each of the opposite faces 62 of the core layer 64. Then, a respective layer of fibrous reinforcement material is positioned over each resin film 2 to form a laminate comprising the core layer 64 between opposite resin films 2, each resin film 2 being covered by a respective layer of fibrous reinforcement material. Then the temperature of the laminate is increased to an elevated temperature to cause the curable resin to melt and flow into the layer of fibrous reinforcement material thereby to wet-out the fibres in the fibrous reinforcement material and to wet-out the faces of the core layer. Thereafter, the prepolymer is polymerized at a curing temperature which is at least as high as the elevated temperature to form, from each composite material layer and layer of fibrous reinforcement material covering the resin film 2, a ply 60 comprising a cured resin matrix containing the fibrous reinforcement material which is bonded to a respective face of the core layer 64, thereby forming the sandwich panel 70.

Alternatively, when the prepreg 52 is used to make the sandwich panel 70, a prepreg 52 is positioned adjacent to each of the opposite faces 62 of the core layer 64 to form a laminate comprising the core layer 64 between opposite prepregs 52. Then, the temperature of the laminate is increased to an elevated temperature to cause the curable resin to melt and flow into the fibrous reinforcement material of the prepregs 52 thereby to wet-out the fibres in the fibrous reinforcement material and to wet-out the faces of the core layer 64. The prepolymer is polymerized at a curing temperature which is at least as high as the elevated temperature to form, from each prepreg 52, a ply 60 comprising a cured resin matrix containing the fibrous reinforcement material which is bonded to a respective face of the core layer 64, thereby forming the sandwich panel 70.

In each embodiment, further layers of resin film 2, prepregs 52, and fibrous reinforcement material may be laid up so that a laminated stack of alternating plies of fibrous reinforcement material and resin film, or a laminated stack of prepregs, is laid up on each face of the core until the desired total fibre weight, with the desired proportions by weight of fibrous reinforcement material and resin, has been achieved.

In some embodiments, layers of resin film 2, prepregs 52, and fibrous reinforcement material may be combined to form a laminated stack comprising plies of fibrous reinforcement material, resin film, and prepregs, the stack having the desired total fibre weight, with the desired proportions by weight of fibrous reinforcement material and resin.

Preferably, for the manufacture of large parts and structures such as wind turbine blades and marine vessels, the curing system is selected to exhibit a peak exotherm temperature within a desired temperature range. The peak exotherm temperature of any given curing system may be defined relative to the curing of a standard polymerisable resin having a specific monomer composition.

In particular, the curing system preferably exhibits a peak exotherm temperature of from 80 to 160° C., more preferably from 100 to 140° C., when evaluated via differential scanning calorimetry (DSC) to cure a model polymerisable resin consisting of a known commercially available methacrylate in place of the vinyl ester resin, used at equivalent parts by weight. In particular the model polymerisable resin consists of 2-hydroxyethyl methacrylate (also known as HEMA or BISOMER HEMA), having CAS number: 868-77-9) containing inhibitor MEHQ (4-methoxyphenol) at a concentration of 200 ppm by weight. Dynamic DSC evaluation of the curative system in the commercially available methacrylate BISOMER HEMA, is carried out over a temperature range of from 25 to 260° C. at a ramp rate of 10° C./min. A suitable machine for such DSC analysis is sold under the trade name “DSC 20” by TA Instruments, which uses a sample size, i.e. a total weight of the 2-hydroxyethyl methacrylate and the free-radical curing system, of from 8 to 16 mg, is suitable the DSC analysis is carried out with the sample under a nitrogen environment. In the DSC evaluation using the model polymerisable resin, the free-radical curing system comprises at least one peroxide curing agent which is present in a total peroxide curing agent concentration of from 0.1 to 3 parts per hundred based on the weight of the 2-hydroxyethyl methacrylate.

The resin film 2 or prepreg 52 according to some preferred embodiments of the present invention is used for the manufacture of wind turbine blades. When a sandwich structure is required, the resin film and/or prepreg is laid up on opposite sides of a central core, as described above.

The resin film 2 or prepreg 52 may be used in a method of manufacturing a wind turbine blade composed of a fibre-reinforced composite material. When using the resin film, 2, layers of fibrous reinforcement material are laid up in a conventional manner in a wind turbine blade mould. For example, an elongate length of the fibrous reinforcement material is unrolled from a roll of the fibrous reinforcement material, and laid up in the mould along the length of the mould. Then a layer of the resin film is unrolled from the roll and laid up over the fibrous reinforcement material.

Typically the elongate lengths of resin film may be oriented at an acute angle to the length of the mould. The resin film may be applied by a roll dispenser mounted on a gantry above the mould, and optionally the positioning of the resin film may be controlled automatically, for example by a robot. Successive adjacent layers of the resin film are laid up over the fibrous reinforcement material so as substantially to cover the fibrous reinforcement material. Then, successive layers of fibrous reinforcement material and resin film are laid up into the mould to form the laminated stack as described above.

A similar production process may be used for other parts and structures to be moulded, in particular large parts such as marine vessels and structural parts therefor. When a boat hull is to be manufactured, the intrinsic tack of the resin film or prepreg may assist in adhering the resin film or prepreg to non-horizontal, even vertical, surfaces, of the fibrous reinforcement material, the core, or the mould, during the lay-up process.

It may readily be seen from FIGS. 1 to 4 that the use of a resin film or prepreg in solid form provides a simplified manufacturing process as compared to liquid infusion, for example in a VARTM process. The resin film and fibrous reinforcement material, or prepregs, are laid up as solid layers in the mould, and then the mould may be closed. The mould is then heated to wet-out the fibres and cure the resin to form the resultant fibre-reinforced composite material. There is no need for a separate system for infusing liquid resin into the closed mould. Since the resin is laid up as a solid layer, the weight per unit area and the positioning of the resin can be accurately controlled, to achieve a high product uniformity and high mechanical properties.

In accordance with the preferred embodiments of the present invention, the resin film 2 and the prepreg 52 comprise a layer of curable resin which is in the form of a solid layer at 20° C.

As used herein, the term “solid” refers to a conventional solid state material as distinguished from a liquid or gas and intends to include those materials known as semi-solids, or flowable solids. The term semi-solid or flowable-solid is used herein to denote the mechano-physical state of a material that is flowable under moderate stress. More specifically, the semi-solid material should have a complex viscosity between about 10,000 and 3,000,000 cps, especially between about 50,000 and 500,000 cps, measured using a rheometer at a strain of 0.125% and 1 Hz oscillation with a 25 mm aluminium parallel plate geometry and 1000 μm gap.

At least 50 wt % of the polymerisable resin comprises at least one polymerisable vinyl ester prepolymer having at least two carbon-carbon unsaturated functional groups. The prepolymer is polymerisable by reaction of the unsaturated functional groups to form a cured resin.

In the preferred embodiments of the present invention, the polymerisable vinyl ester prepolymer has a heat of polymerization of from 110 to 150 KJ/kg, preferably from 120 to 140 KJ/kg, more preferably from 125 to 135 KJ/kg, typically about 130 KJ/kg.

Preferably, the polymerisable vinyl ester prepolymer has a theoretical average, by number, molecular weight of from 750 to 1250, for example from 800 to 1100.

Preferably, the polymerisable vinyl ester prepolymer has less than 2.2 gram equivalents of unsaturation per kilogram of the polymerisable vinyl ester prepolymer.

In the preferred embodiments of the present invention, the polymerisable vinyl ester prepolymer has the structure R1ₙ-R2-R1′m, wherein R1 and R1′ are the same or different and each includes a methacrylate group or acrylate group, n and m are each at least one and may be the same or different, and R2 is polyfunctional and includes a bisphenol moiety, optionally a bisphenol A moiety, and further optionally R2 is an epoxide residue. Typically, R2 has a molecular weight of from 300 to 500, optionally from 350 to 400, further optionally about 370.

Preferably R2 is the reaction product of an epoxy resin and a dicarboxylic acid salt comprising a methacrylate group or acrylate group, optionally dicarboxylic acid salt comprising 2-hydroxyethyl methacrylate phthalate.

In one particularly preferred embodiment, the polymerisable vinyl ester prepolymer has the structure (called “Vinyl ester 1” herein):

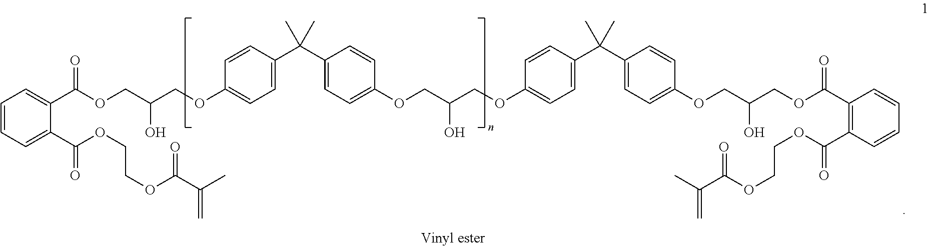

The curable resin further comprises a curing system, which is preferably a free-radical curing system for polymerizing the polymerisable vinyl ester prepolymer.

In the preferred embodiments, the curable resin is a hot-melt resin which is curable by a free-radical curing system.

In the preferred embodiments of the present invention, the free-radical curing system comprises at least one peroxide curing agent having a self-accelerating decomposition temperature (SADT) within the range of from 45 to 95° C. More preferably, the self-accelerating decomposition temperature is within the range of from 50 to 80° C., for example from 55 to 70° C.

Preferably, the at least one peroxide curing agent is present in a concentration of from 0.1 to 3 parts per hundred based on the weight of the polymerisable vinyl ester prepolymer. Preferably, the at least one peroxide curing agent is present in a concentration of from 0.5 to 2 parts per hundred, for example from 0.5 to 1.5 parts per hundred, based on the weight of the polymerisable vinyl ester prepolymer.

In the preferred embodiments of the present invention, the at least one peroxide curing agent is selected from tert-butoxy 2-ethylhexyl carbonate, 2-Butanone peroxide (methyl ethyl ketone peroxide), dibenzoyl peroxide, cyclohexylidenebis[tert-butyl] peroxide, cyclohexylidenebis[tert-amyl]peroxide, cumene hydroperoxide, tert-butylperoxy isopropyl carbonate, tert-butyl peroxybenzoate, tert-butyl peroxy-3,5,5-trimethylhexanoate, 1,1-di(tert-butylperoxy)-3,3,5-trimethylcyclohexane, tert-amyl peroxy-2-ethylhexyl carbonate, di-tert-butyl peroxide, tert-amyl peroxybenzoate, di-tert-amyl peroxide, N-Butyl-4,4-di(tert-butylperoxy)valerate, 1,2-dimethylproplyidene dihydroperoxide and methyl isopropyl ketone peroxide or any mixture of two or more thereof.

Examples of peroxide curing agents that may be used in accordance with the present invention are listed in Table 1.

TABLE 1

| | | | SADT |
|---|---|---|---|
| Peroxide | CAS No. | Trade Names | (° C.) |
| Tert-butoxy 2-ethylhexyl | 34443-12-4 | Luperox TBEC, Trigonox 117 | 60-65 |
| carbonate | | | |
| 2-Butanone peroxide (MEKP) | 94-36-0 | Butanox M50, Butanox LPT-IN | 60 |
| Dibenzoyl peroxide | 94-36-0 | Luperox A98, Perkadox L-W40 | 60-70 |
| Cyclohexylidenebis[tert-butyl] | 3006-86-8 | Trigonox 22-C50, | 70 |
| peroxide | | Luperox 331M80 | |
| Cyclohexylidenebis[tert-amyl] | 15667-10-4 | Luperox 531M80 | 60-65 |
| peroxide | | | |
| Cumene hydroperoxide | 80-15-9 | Luperox CU90, Trigonox K-90 | 55-82 |
| Tert-Butylperoxy isopropyl | 2372-21-6 | Trigonox BPIC-C75, | 65-70 |
| carbonate | | Luperox TBIC M75 | |
| Tert-Butyl peroxybenzoate | 614-45-9 | Trigonox C, Luperox P | 60 |
| Tert-Butyl peroxy-3,5,5- | 13122-18-4 | Trigonox 42S | 55 |
| trimethylhexanoate | | | |
| 1,1-Di(tert-butylperoxy)-3,3,5- | 6731-36-8 | Trigonox 29-C50, Luperox 231 | 60-66 |
| trimethylcyclohexane | | | |
| Tert-amyl peroxy-2-ethylhexyl | 70833-40-8 | Trigonox 131, Luperox TAEC | 65 |
| carbonate | | | |
| Di-tert-butyl peroxide | 110-05-4 | Luperox DI | 80 |
| Tert-amyl peroxybenzoate | 4511-39-1 | Trigonox 127, Luperox TAP, | 65 |
| Di-tert-amyl peroxide | 10508-09-5 | Luperox DTA | 75 |
| N-Butyl-4,4-di(tert- | 995-33-5 | Trigonox 17, Luperox 230 | 75 |
| butylperoxy)valerate | | | |

Trigonox, Luperox, Butanox and Perkadox are Registered Trade Marks

In the preferred embodiments of the present invention, the free-radical curing system further comprises (i) a first auxiliary curing agent comprising a transition metal complex or a transition metal ligand and/or (ii) a second auxiliary curing agent comprising at least one of an aliphatic dione and a nitrogen-containing aliphatic or aromatic compound.

Typically, in the first auxiliary curing agent the transition metal comprises copper or iron.

One preferred first auxiliary curing agent is a copper complex comprising copper acetate and potassium neodecanoate, to provide copper ions with a neodecanoate ligand, in a solvent mixture. The solvent mixture may comprise diethylene glycol and diethanolamine. A suitable copper complex is sold under the trade mark Nouryact® CF12N (CAS Number 142-71-2) by Nouryon.

Another preferred first auxiliary curing agent is an iron complex comprising 2,2′-bipyridine as a ligand for iron ions in a solvent mixture. The solvent mixture may comprise diethylene glycol and diethanolamine. Suitable iron complexes are sold under the trade marks Nouryact® CF30 and Nouryact® CF40, and BORCHI® OXY-CURE, by Nouryon.

A further preferred first auxiliary curing agent is an iron complex comprising iron (1+), chloro[dimethyl-9,9-dihydroxy-3-methyl-2,4-di-(2-pyridylkN)-7-[(2-pyridinyl-kN)methyl]-3,7-diazabicyclo[3.3.1]nonane-1,5-dicarboxylate-kN³, kN⁷]-, chloride(1-). The iron complex may again be in a solvent, for example 2-hydroxy methacrylate. A suitable iron complex is sold under the trade name FeONIX C1-95 by Welychem Catexel and has CAS Number 478945-46-9. Another suitable iron complex is sold under the trade mark Nouryact® CF40 by Nouryon.

Preferably, the first auxiliary curing agent is present in a concentration of from 0.05 to 3.0 parts per hundred based on the weight of the polymerisable vinyl ester prepolymer, more preferably from 0.05 to 1 parts per hundred, for example from 0.075 to 0.3 parts per hundred.

Typically, the nitrogen-containing aliphatic or aromatic compound comprises a substituted or unsubstituted acetamide, aniline or toludine.

Preferably, the aliphatic dione comprises 2,4-pentane dione, ethyl acetoacetate, N,N-diethylacetoacetamide, 3-methyl-2,4-pentanedione, or 3-ethyl-2,4-pentanedione, or any mixture of any two or more thereof, and/or the nitrogen-containing aliphatic or aromatic compound comprises N,N-diethylacetoacetamide, 4,N,N-trimethyl aniline, N,N-diethylaniline or ethoxylated-para-toluidine, or any mixture of any two or more thereof.

Preferably, the second auxiliary curing agent is present in a concentration of from 0.05 to 3.0 parts per hundred based on the weight of the polymerisable vinyl ester prepolymer, more preferably from 0.05 to 1 parts per hundred, for example from 0.075 to 0.5 parts per hundred.

In some embodiments of the present invention, the free-radical curing system may further comprise a curing inhibitor comprising a substituted benzene, optionally 10H-Phenothiazine.

Preferably, the curing inhibitor is present in a concentration of from 0.01 to 1.0 parts per hundred based on the weight of the polymerisable vinyl ester prepolymer, for example from 0.01 to 0.1 parts per hundred.

In the preferred embodiments of the present invention, the polymerisable resin has viscoelastic properties which enables the resin film 2 to be formed as a solid film in a filming process or in a prepregging process to form a prepreg comprising a fibrous layer, and subsequently the film being deposited as a solid layer onto a fibrous layer in a mould, or the prepreg being laid up into a mould, and then upon heating readily and uniformly wet-out the fibrous layer prior to curing of the polymerisable resin.

For example, preferably the polymerisable resin in the resin film, the polymerisable resin additionally comprising the curing system, has a cold Tg of from −15 to 15° C., preferably from −10 to 5° C., measured using a dynamic oscillatory measurement within a temperature range of 40 to −15° C. at a ramp rate of 2° C./minute.

The preferred polymerisable resin has a phase angle (δ) Tonset between a storage modulus and a loss modulus of the polymerisable resin of −5 to 15° C., measured by dynamic oscillatory measurement, 2° C./min, 40 to −15° C. and a displacement of 0.0001 radians by dynamic oscillatory measurement using a 20 mm steel parallel plate geometry with a gap setting of 1000 μm. Preferably, the polymerisable resin has a storage modulus and a loss modulus which are equal within a temperature range of from 65 to 110° C., measured by Dynamic oscillatory measurement, at a strain of 0.125%, 30-130° C. at 1° C./min using a 25 mm aluminium parallel plate geometry with gap setting of 1000 μm.

Preferably, the curable resin has a minimum viscosity within a temperature range of from 65 to 100° C., measured by Dynamic oscillatory measurement, at a strain of 0.125%, 30-130° C. at 1° C./min using a 25 mm aluminium parallel plate geometry with gap setting of 1000 μm.

Preferably, the at least one polymerisable vinyl ester prepolymer of the curable resin, in the absence of any curing system for polymerizing the polymerisable vinyl ester prepolymer, has a viscosity within the range of 30 to 100 Poise, typically from 35-50 Poise, at a temperature of 85° C., measured using a CAP viscometer from AMETEK Brookfield at a shear rate of 0.5-12 s⁻¹, which may be achieved using spindle 3 at a rotational velocity of 50 rpm for a run time of 20 seconds.

In the preferred embodiments of the present invention, the curable resin is free of any particulate filler and/or free of any solvent for the at least one polymerisable vinyl ester prepolymer. Additionally or alternatively, in the preferred embodiments of the present invention, the curable resin consists of the at least one polymerisable vinyl ester prepolymer and a free-radical curing system for polymerizing the polymerisable vinyl ester prepolymer. In the preferred embodiments of the present invention, the curable resin is typically a hot-melt curable resin.

The resin films and prepregs of the preferred embodiments of the present invention have particular application to wind turbine blade construction and the fabrication of production boats. Although different performance, curing and handling characteristics are required for each different application, nevertheless the use of the resin film or prepreg, to avoid the processing difficulties of liquid resin infusion, apply to each application.

In accordance with some preferred embodiments of the present invention, the resin film is a self-curing 1K thermoset resin film. This can be supplied in solid form, for example in a roll, directly to the component fabricator.

The primary benefits of the use of a resin film in accordance with the preferred embodiments of the present invention include:

Reduced material costs—reinforcing fabrics may be procured directly by the end user lowering logistics costs and prepreg conversion costs.

Depending on the resin chemistry other advantages may be realised including:
a. Fast/snap curing for lower production cycle times, which can provide operational expenditure (OPEX) and/or capital expenditure (CAPEX) savings.
b. Reduced/eliminated transportation and storage costs as cold/frozen storage can be reduced or eliminated.
c. Prepreg performance, i.e. high performance, for infusion cost, i.e. low cost
d. Simplified infusion set-up mas compared to VARTM
e. Low resin absorption in core materials
f. Eliminate core finishing costs
g. Controlled blade weight
h. Faster application and lower skill process
i. Reduced consumable waste
j. Option to supply as part of a kit.

Preferably, the 1K resin films may be manufactured in a variety of different film weights for a fabricator to combine with a fabric and produce a laminate.

The resin film is also preferably formulated to have sufficient structure to prevent the resin inadvertently flowing during storage and transportation under the forces exerted when supplied in large rolls. Preferably, the resin molecular weight is increased or advanced to limit “cold flow”.

In accordance with the preferred embodiments of the present invention, the resin film comprises a styrene-free (meth)acrylate resin cured with an accelerated peroxide curing agent provided short processing times and low material costs.

In addition, in accordance with the preferred embodiments of the present invention, the resin film exhibits increased cold flow resistance to provide dimensional stability when supplied as a roll of unreinforced resin. This may be achieved through acid modification during the base resin synthesis, which acts to increase the molecular weight, and therefore lower the tack and increase the cold flow resistance.

In accordance with the preferred embodiments of the present invention, the resin film exhibits reliable process stability, shelf life and curing by the use of the combination of a peroxide curing agent and accelerator(s) which are selected and used in concentrations to increase shelf life, even at high storage temperatures, yet provide rapid and low temperature curing, for example a curing time of from 1 to 2 hours at a curing temperature of 80° C.

In accordance with the preferred embodiments of the present invention, during use of the resin film, unlike the use of a prepreg system, the fibrous reinforcement is not pre-wet with matrix resin. In addition, the use of a radical curing agent for curing the polymerisable resin can ensure that the viscosity does not increase straight away when curing, providing a period of time for wet-out and “fibre washing” prior to viscosity increase and matrix gelation.

However, as described above, the present invention also has alternative embodiments in which the composite material layer comprises a prepreg, and many of the same technical advantages as described above for the resin when used as a resin film can be achieved when using the same resin in a prepreg.

In particular, when manufacturing sandwich panels the same technical advantage of improved laminate-core adhesion, which can be measured using climbing drum peel strength, and is believed to result from reduced laminate-core inhibition as a result of using the curable resin composition employed in accordance eth the present invention, can be achieved when the curable resin is used as a resin film or when the curable resin is used in a prepreg.

In accordance with the preferred embodiments of the present invention, the combination of the curable resin and the radical curing agent for curing the curable resin may be formulated to provide a low temperature (e.g. within the range of about 70 to 80° C.) curing system to suit low temperature curing which is desirable for the manufacture of large components.

Typically, the composite material layer, when used as a resin film or a prepreg in accordance with the preferred embodiments of the present invention, exhibits one or more of the following properties:

The resin is self-adhesive (i.e. has some tack) and is flexible, and when used as a film has sufficient tear strength and tensile strength to be formed in a range of different film weights, for example from 20 to 1000 g/m², and can be stored in a rolled format without distorting or tearing. The tack is sufficient to enable in-mould positioning of the resin film or prepreg at the desired location.

The curable resin in the resin film or prepreg has sufficient “shelf life” to remain stable for several months without the requirement to store in refrigerated environments. The storage does not distort or flow on the roll during storage, and can be stored in ambient conditions without gelation occurring.

In accordance with the preferred embodiments of the present invention, the resin film or prepreg has a shelf life of 6 months when stored at room temperature (20° C.), following manufacture using a filming step or a prepregging step carried out at a temperature within the range of from 60 to 70° C.

The resin film or prepreg can be laminated with glass, carbon or other fibre reinforcements to fabricate a composite laminate.

The curable resin in the resin film or prepreg can be subjected to an elevated temperature, for example greater than 60° C., within a preferred temperature range of from 60 to 70° C., during the filming step of the preparation of the resin film, or during a prepregging step, and the resin does not cure, or gel adversely during preparation of the film or prepreg.

The curable resin has a gel time of from 10 to 60 minutes, preferably from 15 to 45 minutes, more preferably from 25 to 40 minutes, at a temperature of 70° C.

In this specification, the “gel time” is measured with a 100 gram sample, and uses the “Tecam” method, as defined herein. The specific testing protocol for measuring the gel time of the curable resin is defined as follows: 100 g of the polymerisable resin in an open-topped container was placed within a 70° C. (+/−0.2° C.) waterbath. A commercially available Gelation Timer, available in commerce from Techne under the trade name Techne® GT6, was then used to determine the point at which the polymerisable resin reaches gelation point. A buoyant plunger is suspended in the heated resin from a driven mechanism imparting simple harmonic motion of fixed amplitude in a vertical plane and coupled so that the plunger is positively raised during the upstroke, but is free to fall at a rate not faster than the simple harmonic motion on the down stroke. The gelation time is measured as the period between completion of the addition of the free-radical curing system to the resin system and the automatic detection of the movement when gelation of the resin becomes sufficient for the mixture just to support the plunger. The standard protocol of the Techne® FGT6 Gelation Timer was used which provides an accuracy of the gelation time, i.e. the “gel time”, to within +/2%.

The chemistry used in the polymerisable prepolymer and curative system is solvent-free and volatile-free and free, or substantially free, of highly toxic chemicals such as CMRs (chemicals which are carcinogenic, mutagenic or toxic to reproduction) and SVHCs (chemicals which are designated substances of very high concern). The curable resin is preferably a hot-melt resin.

Upon exposure to heat and pressure, the resin lowers in viscosity to impregnate and wet-out the fibre reinforcement forming a composite structure. The reactivity of the resin system is such that it provides enough time and a sufficient low enough viscosity to allow this to happen without curing.

Once the reinforcement has been wet, the resin rapidly crosslinks to form a cured thermoset composite of sufficient thermal and mechanical properties for the intended applications including wind turbine blade and marine craft.

The curable resin has a reaction onset temperature within the range of from 80 to 100° C., preferably from 85 to 95° C., as measured by dynamic scanning calorimetry (DSC) over a temperature range of from 25 to 260° C. at a ramp rate of 10° C./minute.

The resin preferably has an enthalpy of from 100 to 200 Joules/gram, more preferably from 115 to 150 Joules/gram, as measured by dynamic scanning calorimetry (DSC) over a temperature range of from 25 to 260° C. at a ramp rate of 10° C./minute. The resin preferably exhibits a peak temperature upon curing within the range of from 80 to 130° C., more preferably from 90 to 110° C., as measured by dynamic scanning calorimetry (DSC) over a temperature range of from 25 to 260° C. at a ramp rate of 10° C./minute, under a nitrogen environment.

The speed of curing is sufficiently rapid to allow a reduction in manufacturing “cycle time” remaining economical (typically <2 hours depending on cure temperature, which is preferably below 100° C.).

The temperature of curing is sufficiently low, preferably below 100° C., for example a curing temperature of 80° C., to facilitate the use of low temperature tooling which is associated with lower tooling manufacturing and material costs, reduce energy consumption during cure and lower curing cycle times.

The present invention is further described with reference to the following non-limiting Examples.

### Example 1

The Applicant's earlier WO-A-2011/073111 discloses vinyl ester resins which are synthesised using a two-step process. In a first step 2-hydroxyethylmethacrylate (Hema) is reacted with phthalic anhydride to form Hema phthalate as shown by the reaction below:

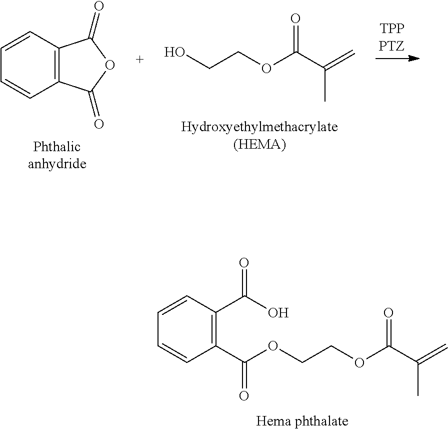

Thereafter, in a second step the Hema phthalate is reacted with liquid bisphenol A epoxy resin as shown by the reaction below to produce a vinyl ester called herein “vinyl ester 1”:

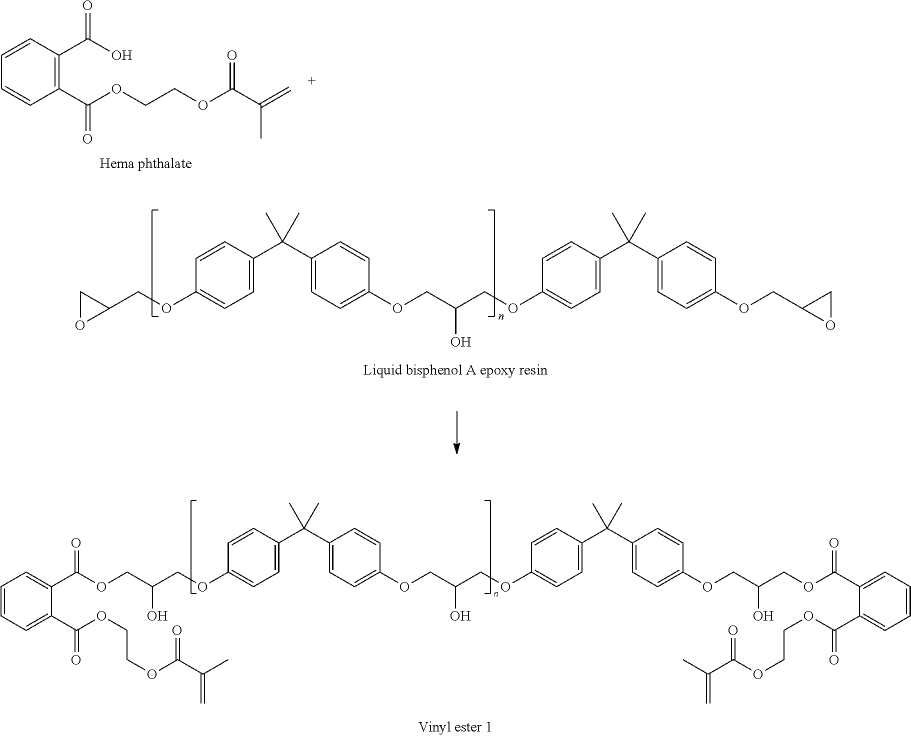

Hema phthalate was synthesized using the reaction scheme disclosed in Example 1 of WO-A-2011/073111. In order to synthesise the Hema phthalate, 2-hydroxyethyl methacrylate was added to a reactor having a top cover and which was sparged with a flow of air passing through the reactor. The 2-hydroxyethyl methacrylate was agitated and heated to at least 80° C. A catalytic amount of Triphenylphosphine (TPP) was added followed by a stoichiometric amount of phthalic anhydride. Following dissolution of all the phthalic anhydride, the reaction was allowed to continue until the viscosity levelled-off. The reaction period was between 4-10 hours. Phenothiazine (PTZ) was then added as an inhibitor, and was allowed to dissolve.

In order to synthesise the vinyl ester 1, the Hema phthalate was agitated and air sparged at all times throughout the subsequent synthesis. To the Hema phthalate, at a temperature of at least 80° C., a second amount of triphenylphosphine (TPP) was added followed by a liquid bisphenol A epoxy resin, in particular an epoxy resin sold by The Dow Chemical Company under the trade name DER™ 330, which is a liquid epoxy resin which is a reaction product of epichlorohydrin and bisphenol A. The reaction was maintained at a temperature of at least 100° C. until the viscosity levelled-off. It was ensured that the viscosity had stabilised; determined as any change in viscosity over a 1 hour period being <5 Poise (as measured at 85° C. using a cone and plate method), before dispensing the vinyl ester prepolymer.

In order to form the curable resin film, the vinyl ester prepolymer was then mixed with the free-radical curing system. In this example, the free-radical curing comprised, for 100 parts by weight of the synthesised vinyl ester prepolymer, 1.0 part by weight of BUTANOX LPT-IN as a first peroxide curing agent, 0.1 parts by weight of part by weight of Nouryact CF12N as a first auxiliary curing agent and 0.1 parts by weight of 2,4-pentanedione as a second auxiliary curing agent.

The vinyl ester prepolymer was preheated to a temperature within the range of from 60 to 65° C. and the free-radical curing system was mixed into the vinyl ester prepolymer to achieve a homogeneous product, using a dual asymmetric centrifugal mixer. The auxiliary curing agents were added first and mixed in, and then the peroxide curing agents were added and mixed in.

Directly after mixing the vinyl ester prepolymer and the free-radical curing system, the homogeneous resin was formed into a resin film using a filming step. In the filming step, the resin was deposited onto a polyester scrim fabric having an areal weight of 15 gsm which was over a paper backing sheet. The desired film thickness was achieved using a heated knife over a roller.

The resultant vinyl ester 1 provided a polymerisable resin prepolymer for which the cold Tg (measured for the resin alone) and resin viscosity at 85° C. (measured for the combination of the resin and the curing system) were acceptable.

The resultant hot melt curable resin film comprising vinyl ester 1 resin and the above-described curing system had the following properties, using the measurement methods described herein:

Rheology, i.e. parameters that define the cure performance of the material, wet-out characteristics, stability on the roll and tack:
(i) Cold Tg −7.53° C.—measured for the combination of the resin and the curing system and defined by storage and loss modulus cross-over point (G′=G″), as measured by dynamic oscillatory measurement, 2° C./min, 40 to −15° C. and a displacement of 0.0001 radians by dynamic oscillatory measurement using a 20 mm steel parallel plate geometry with a gap setting of 1000 μm.
(ii) Gelation temperature 77.27° C.—defined by storage and loss modulus cross-over point (G′=G″), as measured by Dynamic oscillatory measurement, at a strain of 0.125%, 30-130° C. at 1° C./min using a 25 mm aluminium parallel plate geometry with gap setting of 1000 μm.
(iii) Phase angle (δ) Tonset between a storage modulus and a loss modulus of the polymerisable resin −1.6° C. as measured by dynamic oscillatory measurement, 2° C./min, 40 to −15° C. and a displacement of 0.0001 radians using a 20 mm steel parallel plate geometry with a gap setting of 1000 μm.

A suitable instrument for such measurements is a TA Instruments DHR-2 Rheometer.

Gel time, i.e. parameter that defines the material's manufacturability and storage stability at ambient temperatures:
(i) 31 minutes gel time at 70° C.—measured by the Tecam method with a 100 g sample, as defined above.

Resin viscosity i.e. parameter that defines stability to flow-on-the-roll, wet-out and tack:
(i) Resin viscosity (resin alone, without cure agents) 40 Poise—measured using a CAP viscometer, spindle 3, 50 rpm, 20 seconds run time, 85° C.
(ii) Mixed system minimum viscosity temperature 75.6° C.—measured by Dynamic oscillatory measurement, at a strain of 0.125%, 30-130° C. at 1° C./min using a 25 mm aluminium parallel plate geometry with gap setting of 1000 μm.

Reaction temperature and enthalpy, i.e. parameters that define storage stability at room temperature, cure performance and manufacturability:
(i) Reaction Onset Temperature=93.57° C.
(ii) Enthalpy of Reaction 135.2 J/g;
(iii) Peak Temperature 109.1° C.—all measured by dynamic scanning calorimetry, 10° C./min, 25-260° C.

The isothermal conversion, otherwise known as cure conversion or “through-cure”, was measured via DSC using an isothermal measurement using the following protocol: ramp to from 25-80° C. (80° C. being the isothermal temperature in this example) at 100° C./min followed directly by a 2 hour dwell at 80° C. (isothermal evaluation step). This is then followed by a dynamic scan to determine residual enthalpy, and which was measured as follows: system is cooled directly from the isothermal temperature (80° C. in this example) to 25° C. at 20° C./min and directly followed by a ramp 25-260° C. at 10° C./min. The isothermal conversion may be considered a suitable method for evaluating “though-cure” and is calculated by:

Isothermal Enthalpy/(Isothermal Enthalpy+Residual Enthalpy)*100

For the above calculation, the isothermal enthalpy was calculated via a peak integration with an extrapolated baseline, and the residual enthalpy was calculated via a peak integration using a linear baseline.

The instrument used for this measurement was a TA DSC Q20, using the analysis software TA Instruments Universal Analysis 2000 Version 4.5, both commercially available from TA Instruments.

In this Example 1, the isothermal conversion was measured as 80.80%.

Some of these parameters are summarised in Table 2 below.

TABLE 2

| | Analytical | | | | | Comparative | | Comparative |
|---|---|---|---|---|---|---|---|---|
| Parameter | Methodology | Example 1 | | Example 2 | | Example 1 | | Example 2 |
| G′ = G″ | Rheology | −7.53° | C. | Not tested | | −6.8° | C. | N/A |
| | 40 to −15° C. | | | | | | | |
| G′ = G″ | Rheology | 77.27° | C. | Not tested | | 80.046° | C. | N/A |
| | 30-110° C. | | | | | | | |
| Minimum | Rheology | 75.6° | C. | Not tested | | 78.36° | C. | N/A |
| Viscosity | 30-110° C. | | | | | | | |
| Gel Time | TECAM | 31 | mins | 15 | mins | 34 | mins | 1 min |
| | 70° C. | | | | | | | |
| Reaction Onset | DSC | 93.57° | C. | 85.81° | C. | 102.15° | C. | N/A |
| Temperature | 25-260° C. | | | | | | | |
| Enthalpy | DSC | 135.2 | J/g | 158.5 | J/g | 124.1 | J/g | N/A |
| | 25-260° C. | | | | | | | |
| Peak | DSC | 109.1° | C. | 102.27° | C. | 111.57° | C. | N/A |

| | | | | | |
|---|---|---|---|---|---|
| Temperature | 25-260° C. | | | | |
| Isothermal | DSC | 80.80% | 81.30% | 78.20% | N/A |
| Conversion | 100° C. Ramp | | | | |
| | 25-80° C. | | | | |
| | 2 hrs at 80° C. | | | | |

The inventors have found that the combination of the vinyl ester prepolymer and the free-radical curing system of Example 1 exhibited a desired balance of properties enabling the manufacture of a resin film and/or prepreg while also minimizing any action of inhibiting agents, and any resulting cure inhibition, at a laminate-core interface during the manufacture of a sandwich panel.

In particular, it is noted that the gel time at 70° C. was 31 minutes, the reaction onset temperature was 93.57° C. and the isothermal conversion was 80.80%.

The gel time of 31 minutes at 70° C. represents a hot melt vinyl ester resin-curing agent system with a suitable reactivity to withstand the mixing, filming and prepregging processes required for a solid film or prepreg resin system, such filming and prepregging processes being carried out within a preferred temperature range of from 60 to 70° C.

A sandwich panel was manufactured using the combination of the vinyl ester prepolymer and the free-radical curing system of Example 1 as described below.

The sandwich panel construction comprised a single fibre-reinforced resin matrix composite material laminate bonded on each side of a cellular foam core. The cellular foam core comprised a PET foam sheet having a density of 100 kg/m³ and a thickness of 25 mm. Each single fibre-reinforced resin matrix composite material was produced by curing a single prepreg layer which had the following structure: the prepreg comprised a laminate consisting of three resin films laminated in an alternating layer structure with two plies of a woven fabric composed of glass fibres, to provide the laminate structure resin/glass/resin/glass/resin. The resin films each had an areal weight of 315 gsm. The woven fabric composed of glass fibres was a woven E-glass fabric having an areal weight of 580 gsm, which is available in commerce under the trade name WRE581 from Gurit(UK) Ltd. This sandwich panel construction was then cured using a vacuum assisted process using the cure process: ramp from room temperature to 80° C. at 1° C./min then dwell for 2 hours at 80° C.

The adhesion strength between the cured fibre-reinforced resin matrix composite material laminate and PET core in the sandwich panel construction was measured using a climbing drum peel strength test as follows: a climbing drum peel test was carried out according to the standard EN2243-3, using coupons sized 300 mm×75 mm. This climbing drum peel test resulted in a peeling strength of 118.4 N.

The climbing drum peel test attempts to pull the cured fibre-reinforced resin matrix composite material laminate away from the PET core.

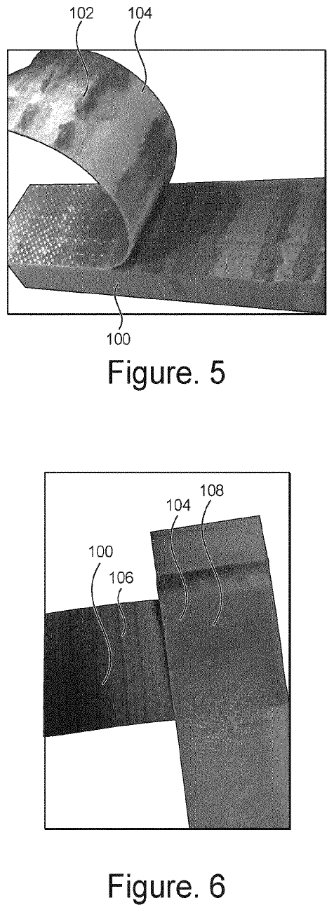

FIG. 5 is a photograph which illustrates the tested sample after conducting the climbing drum peel test on the sandwich panel construction using the combination of the vinyl ester prepolymer and the free-radical curing system of Example 1 and the PET cellular foam core.

FIG. 5 shows that residual portions 102 of the core 100 remained adhered to the cured laminate 104 after the peel test. This result shows that the failure mode resided within the core, which evidences a high, and acceptable, level of adhesion between the laminate and the core.

### Example 2

In Example 2, the same vinyl ester prepolymer used in Example 1 was cured, but using a different free-radical curing system. In Example 2, the free-radical curing system consisted of: BUTANOX LPT-IN—1.0 phr as the peroxide curing agent, and Nouryact CF12N—0.1 phr as the first auxiliary curing agent, both of which agents were used in Example 1. No second auxiliary curing agent was present.

The same curing protocol as used in Example 1 was used to cure the hot melt curable resin of Example 2. The rheological properties, gel time, reaction temperature and enthalpy, and resin viscosity were measured as described above for Example 1, and the results are also shown in Table 2.

The inventors have found that the combination of the vinyl ester prepolymer and the free-radical curing system of Example 2 also exhibited a desired balance of properties enabling the manufacture of a resin film and/or prepreg while also minimizing any action of inhibiting agents, and any resulting cure inhibition, at a laminate-core interface during the manufacture of a sandwich panel.

In particular, it is noted that the gel time at 70° C. was 15 minutes, the reaction onset temperature was 85.81° C. and the isothermal conversion was 81.30%.

The gel time of 15 minutes at 70° C. represents a hot melt vinyl ester resin-curing agent system with a suitable reactivity to withstand the mixing, filming and prepregging processes required for a solid film or prepreg resin system, such filming and prepregging processes being carried out within a preferred temperature range of from 60 to 70° C.

As for Example 1, in Example 2 the adhesion between the cured fibre-reinforced resin matrix laminate and a cellular foam core, in particular composed of PET, was evaluated qualitatively in a sandwich laminate construction having the same structure, and using the same curing protocol, as described above for Example 1.

The resultant sandwich panel again showed a failure mode primarily in the PET core on de-bonding the laminate from the PET core. No tack was clearly evident on the de-bonded laminate or PET core surface.

The free-radical curing system of Example 2 was therefore shown also to suitable for use curing a vinyl ester prepolymer for the manufacture of a solid resin film or prepreg resin system.

### Comparative Example 1

In this comparative example, a hot melt vinyl ester resin-curing agent system was produced which was capable of producing laminates free of air-inhibition after curing for a period of 2 hours at a cure temperature of 80° C. cure under a vacuum process. However, in comparison to the good results of Examples 1 and 2 with regard to achieving a high adhesion strength between a laminate and a core in a sandwich panel, in this comparative example the hot melt vinyl ester resin-curing agent system suffered from PET core-laminate inhibition, leading to an unacceptably low adhesion strength between a laminate and a core in a sandwich panel.

In Comparative Example 1, again the same vinyl ester prepolymer used in Examples 1 and 2 was cured, but using a different free-radical curing system. In Comparative Example 1, the free-radical curing system consisted of: LUPEROX TBEC—1.0 phr and MEKP (2-Butanone peroxide)—0.3 phr (available in commerce from Merck) as the peroxide curing agents, Nouryact CF12N—0.3 phr as the first auxiliary curing agent, and 2,4-pentanedione—0.3 phr as the second auxiliary curing agent.

The same curing protocol as used in Example 1 was used to cure the curable resin of Comparative Example 1. The rheological properties, gel time, reaction temperature and enthalpy, and resin viscosity were measured as described above for Example 1, and the results are also shown in Table 2.

The gel time of 34 minutes at 70° C. is indicative of a free-radical curing system with suitable reactivity to withstand the mixing, filming and prepregging processes for a solid film and/or prepreg resin, such filming and prepregging processes being carried out within a preferred temperature range of from 60 to 70° C.

Again, as for Examples 1 and 2, in Comparative Example 1 the adhesion between the cured fibre-reinforced resin matrix laminate and a cellular foam core, in particular composed of PET, was evaluated qualitatively in a sandwich laminate construction having the same structure, and using the same curing protocol, as described above for Example 1.

The adhesion strength was again measured using the same climbing drum peel test described in Examples 1 and 2. The measured peeling strength was 24.2 N, which is unacceptable, and significantly lower than the climbing drum peeling strength of 118.4 N achieved in Example 1.

When the laminate of a sandwich panel produced in Comparative Example 1 is de-bonded from the PET core, the failure was seen to be predominately at the PET core-laminate interface, as show in FIG. 6, FIG. 6 shows substantially no portions of core 100 remaining on the surface of the laminate 104. The de-bonded laminate 104 also had a noticeably tacky surface 108, of the side facing the core 100, and the exposed core surface 106 was also tacky.

### Comparative Example 2

In this comparative example, a hot melt vinyl ester resin-curing agent system was produced which was capable of producing laminates free of air-inhibition after curing for a period of 2 hours at a cure temperature of 80° C. cure under a vacuum process. However, in comparison to the good results of Examples 1 and 2 with regard to achieving a high adhesion strength between a laminate and a core in a sandwich panel, in this comparative example the hot melt vinyl ester resin-curing agent system suffered from PET core-laminate inhibition, leading to an unacceptably low adhesion strength between a laminate and a core in a sandwich panel.

In Comparative Example 2, again the same vinyl ester prepolymer used in Examples 1 and 2 was cured, but using a different free-radical curing system. In Comparative Example 2, the free-radical curing system consisted of: BUTANOX LPT-IN—1.0 phr as the peroxide curing agent, and Nouryact CF12N—0.2 phr as the first auxiliary curing agent. No second auxiliary curing agent was present.

The gel time of only 1 minute at 70° C. meant that the free-radical curing system caused the resin to gel almost immediately after mixing.

Consequently, such a hot melt vinyl ester resin-curing agent system cannot withstand the mixing, filming and prepregging processes for a solid film and/or prepreg resin, and so cannot be used to make a solid resin film or a prepreg using filming or prepregging processes carried out within a temperature range of from 60 to 70° C.

Moreover, the rheological properties, reaction temperature and enthalpy, and resin viscosity could not be measured, as shown in Table 2. The hot melt vinyl ester resin-curing agent system could not be used to make a sandwich panel.

### Discussion of Examples and Comparative Examples

The Examples and Comparative Examples show that in a vinyl ester film infusion process, which uses a solid layer of the vinyl ester resin, even if air-inhibition has been minimised with the use of a suitable combination of cure package and elevated cure temperature, inhibition can also be found at the interface between the fibre-reinforced resin matrix composite material (i.e. the resin-fibre laminate) and the core. This core-laminate interface inhibition is evidenced when the resin-fibre laminate is de-bonded from the core as a tacky surface on the resin-fibre laminate, i.e. on the core-facing side of the resin-fibre laminate, and a tacky core surface, i.e. on the laminate-facing side of the core. Such core-laminate interface inhibition is also evidenced following de-bonding, where the failure mode is primarily at the interface, which is exhibited by minimal core remaining bonded to the laminate after separation of the laminate from the core. In contrast, a desirable and strong bond is achieved when the failure-mode is primarily within the core, which is exhibited by the de-bonded laminate being covered in a residual portion of the bonded core.

Without being bound by any theory, it is believed that an increased rate of reaction, and/or increased reaction conversion (also known as “through-cure”) has a favourable effect in minimising PET core-laminate interface inhibition. The cause of this may be found in the vinyl ester free-radical cure mechanism, consisting of initiation, propagation and termination steps

In the initiation step, the radical initiator, in this case a peroxide, decomposes into two active organic radicals. The initiator decomposition rate constant is known to be temperature dependent. In the propagation step, a chain carrier is formed from the reaction of a free radical and a monomer species, and chain propagation then proceeds rapidly, thereby producing a polymer. In the termination step, multiple processes may occur to cease activity of the radical species, such as: interaction of two active chain ends and/or reaction of an active chain end with an initiator radical and/or termination by transfer of the active centre to another molecule (solvent, inhibiting agent etc.).

The inhibiting agents active at the laminate-PET core interface will impact the rate of the termination step. The impact of such inhibiting agents can be envisaged to be minimised using a suitable cure package that ensures the rate of radical generation is significantly greater than the rate of termination, thereby providing conditions for desirable polymerisation. An increase in temperature is also envisaged to increase the rate of radical generation relative to that of inhibiting agent induced termination processes.

In balance with this is the industrial desire to cure at lower temperatures resulting in a limitation to which temperature can be utilised to increase the rate of reaction and temper the action of inhibiting agents at the PET core-laminate interface and the resulting cure inhibition at the laminate-PET core interface.

The present inventors have found that a suitable system to achieve adhesion to PET core using a low temperature cure which is desired for the manufacture of large components would therefore have an isothermal conversion at 80° C. of 80-95%

More pertinently for film infusion and/or prepreg applications therefore is usage of a cure package that delivers a significant reactivity at the desired cure temperature (e.g. 80° C.) and to counteract the action of inhibiting agents at the PET core-laminate interface and the resulting cure inhibition at the laminate-PET core interface. However, such a cure package must be balanced with manufacturing requirements for a solid resin film or prepreg system.

The solid resin film or prepreg system is known to consist of a solid resin which must be heated, thereby reducing the resin viscosity, to enable mixing of the cure package, and subsequent filming or a subsequent prepregging process. For example, using vinyl ester 1 as described above, a suitable temperature for such filming and prepregging processes has been found to be within the range of 60 to 70° C., in particular 65° C. For vinyl ester 1, additionally the resin viscosity is 40 P at 85° C.

A highly reactive system will therefore begin polymerisation at such temperatures upon mixing, having a detrimental effect on the filming and prepregging processes, and the final product properties (e.g. shelf life). A trade off therefore is required within the cure package that enables the rate of initiation and propagation to be sufficient to counteract the action of inhibiting agents at the PET core-laminate interface and the resulting cure inhibition at the laminate-PET core interface. Yet the cure package must not be so reactive that it cannot be mixed with a suitable solid resin system at the elevated temperatures required for mixing, filming and prepregging, such filming and prepregging processes being carried out within a preferred temperature range of from 60 to 70° C.

The Examples and Comparative Examples show that in a vacuum assisted film infusion and cure process, the use of a particular cure package for a hot melt vinyl ester resin, when subjected to a cure for 2 hours at 80° C., or even 2 hours at 70° C., has been found to minimise the impact of air inhibition, which would otherwise be manifested by the presence of an outermost resin layer which is acetone-sensitive and/or a potentially tacky. Indeed, it has been established that curing at higher temperatures, e.g. 100° C. (relative to 80° C.) reduces susceptibility to air inhibition. However, lower cure temperatures are desirable by the marine and wind industries.

The present inventors have therefore found that that when making a composite material layer comprising a curable resin which is in the form of a solid layer at 20° C., wherein at least 50 wt % of the curable resin comprises at least one polymerisable vinyl ester prepolymer having at least two carbon-carbon unsaturated functional groups, and the prepolymer is polymerisable by reaction of the unsaturated functional groups to form a cured resin by use of a free-radical curing system for polymerizing the polymerisable vinyl ester prepolymer, the selection of a combination of particular curing properties of the curable resin can enable the composite material layer to be manufactured in the form of a prepreg or a resin film, yet after curing enables a high-quality sandwich panel to be manufactured which exhibits strong adhesion of the resin, used in a laminate formed from the prepreg or resin film, to a core.

In particular, it has been found unexpectedly that by providing the combination of technical features that (i) the curable resin has a reaction onset temperature within the range of from 80 to 100° C., preferably from 85 to 95° C., as measured by dynamic scanning calorimetry (DSC) over a temperature range of from 25 to 260° C. at a ramp rate of 10° C./minute, and (ii) the curable resin has a gel time of from 10 to 60 minutes, measured at a temperature of 70° C., the curable resin can exhibit high adhesion strength in a sandwich panel, as determined using a climbing drum peel test, using a relatively low temperature curing process (typically applying a curing temperature of about 70-80° C.), which low temperature is required when manufacturing large structural components such as wind turbine blades and marine vessels or parts therefor, and yet the resin can form a prepreg, and can readily be impregnated into fibrous reinforcement material to form the prepreg, or can form a resin film, to form a solid resin layer.

Therefore the present invention can provide a resin which can be readily employed to form a prepreg, or a resin film, each incorporating a solid resin layer, without the resin prematurely curing, but which can also be employed to make high quality sandwich panels exhibiting high laminate-core adhesion, even though the sandwich panels can be cured at relatively low temperatures, such as a within a curing temperature range of from about 70-80° C., which is particularly advantageous for the manufacture of large components.

1. A composite material layer, the composite material layer comprising a curable resin which is in the form of a solid layer at 20° C., wherein the composite material layer comprises a prepreg comprising at least one ply of fibrous reinforcement material which is at least partly impregnated by the curable resin or the composite material layer comprises a film of the curable resin, wherein at least 50 wt % of the curable resin comprises at least one polymerisable vinyl ester prepolymer having at least two carbon-carbon unsaturated functional groups, the prepolymer being polymerisable by reaction of the unsaturated functional groups to form a cured resin, wherein the curable resin further comprises a free-radical curing system for polymerizing the polymerisable vinyl ester prepolymer, wherein the curable resin has a reaction onset temperature within the range of from 80 to 100° C., as measured by dynamic scanning calorimetry (DSC) over a temperature range of from 25 to 260° C. at a ramp rate of 10° C./minute, and the curable resin has a gel time of from 10 to 60 minutes, measured at a temperature of 70° C.

2. A composite material layer according to claim 1 wherein the free-radical curing system comprises at least one peroxide curing agent having a self-accelerating decomposition temperature within the range of from 45 to 95° C., from 50 to 80° C., or from 55 to 70° C.

3. A composite material layer according to claim 2 wherein the at least one peroxide curing agent is selected from tert-butoxy 2-ethylhexyl carbonate, 2-butanone peroxide (methyl ethyl ketone peroxide), dibenzoyl peroxide, cyclohexylidenebis[tert-butyl] peroxide, cyclohexylidenebis[tert-amyl] peroxide, cumene hydroperoxide, tert-butylperoxy isopropyl carbonate, tert-butyl peroxybenzoate, tert-butyl peroxy-3,5,5-trimethylhexanoate, 1,1-di(tert-butylperoxy)-3,3,5-trimethylcyclohexane, tert-amyl peroxy-2-ethylhexyl carbonate, di-tert-butyl peroxide, tert-amyl peroxybenzoate, di-tert-amyl peroxide, N-Butyl-4,4-di(tert-butylperoxy)valerate, 1,2-dimethylproplyidene dihydroperoxide and methyl isopropyl ketone peroxide or any mixture of two or more thereof.

4. A composite material layer according to claim 2 wherein the at least one peroxide curing agent is present in a concentration of from 0.1 to 3 parts per hundred, from 0.5 to 2 parts per hundred, or from 0.5 to 1.5 parts per hundred, based on the weight of the polymerisable vinyl ester prepolymer.

5. A composite material layer according to claim 2 wherein the free-radical curing system further comprises a first auxiliary curing agent comprising a transition metal complex or a transition metal ligand.

6. A composite material layer according to claim 5 wherein in the first auxiliary curing agent the transition metal comprises copper or iron, or wherein the first auxiliary curing agent comprises a copper complex comprising coper acetate and potassium neodecanoate.

7. A composite material layer according to claim 5 wherein the first auxiliary curing agent is present in a concentration of from 0.05 to 3.0 parts per hundred, from 0.05 to 1 parts per hundred, or from 0.075 to 0.3 parts per hundred, based on the weight of the polymerisable vinyl ester prepolymer.

8. A composite material layer according to claim 2 wherein the free-radical curing system further comprises a second auxiliary curing agent comprising at least one of an aliphatic dione and a nitrogen-containing aliphatic or aromatic compound, the nitrogen-containing aliphatic or aromatic compound optionally comprising a substituted or unsubstituted acetamide, aniline or toludine.

9. A composite material layer according to claim 8 wherein the aliphatic dione comprises 2,4-pentane dione, ethyl acetoacetate, N,N-diethylacetoacetamide, 3-methyl-2,4-pentanedione, or 3-ethyl-2,4-pentanedione, or any mixture of any two or more thereof, and/or the nitrogen-containing aliphatic or aromatic compound comprises N,N-diethylacetoacetamide, 4,N,N-trimethyl aniline, N,N-diethylaniline or ethoxylated-para-toluidine, or any mixture of any two or more thereof.

10. A composite material layer according to claim 8 wherein the second auxiliary curing agent is present in a concentration of from 0.05 to 3.0 parts per hundred, from 0.05 to 1 parts per hundred or from 0.075 to 0.5 parts per hundred, based on the weight of the polymerisable vinyl ester prepolymer.

11. A composite material layer according to claim 1 wherein the curable resin has any one or any combination of:
(i) a cold Tg of from −15 to 15° C., measured by dynamic oscillatory measurement, 2° C./min, 40 to −15° C. and a displacement of 0.0001 radians by dynamic oscillatory measurement using a 20 mm steel parallel plate geometry with a gap setting of 1000 μm;
(ii) a phase angle (δ) Tonset delta between a storage modulus and a loss modulus of from −5 to 15° C., measured by dynamic oscillatory measurement, 2° C./min, 40 to −15° C. and a displacement of 0.0001 radians by dynamic oscillatory measurement using a 20 mm steel parallel plate geometry with a gap setting of 1000 μm; and/or
(iii) a storage modulus and a loss modulus which are equal within a temperature range of from 65 to 105° C., measured by Dynamic oscillatory measurement, at a strain of 0.125% strain, 30-130° C. at 1° C./min using a 25 mm aluminium parallel plate geometry with gap setting of 1000 μm.

12. A composite material layer according to claim 1 wherein the polymerisable vinyl ester prepolymer has a heat of polymerization of from 110 to 160 KJ/kg, or from 120 to 160 KJ/kg.

13. A composite material layer according to claim 1 wherein the polymerisable vinyl ester prepolymer has a theoretical average, by number, molecular weight of from 750 to 1250, or from 800 to 1100.

14. A composite material layer according to claim 1 wherein the polymerisable vinyl ester prepolymer has less than 2.2 gram equivalents of unsaturation per kilogram of the polymerisable vinyl ester monomer.

15. A composite material layer according to claim 1 wherein the polymerisable vinyl ester prepolymer has the structure R1ₙ-R2-R1′ₘ, wherein R1 and R1′ are the same or different and each includes a methacrylate group or acrylate group, n and m are each at least one and may be the same or different, and R2 is polyfunctional and includes a bisphenol moiety, optionally a bisphenol A moiety, and further optionally R2 is an epoxide residue.

16. A composite material layer according to claim 15 wherein R2 has a molecular weight of from 300 to 500, from 350 to 400, or about 370.

17. A composite material layer according to claim 15 wherein R2 is the reaction product of an epoxy resin and (i) dicarboxylic acid salt comprising a methacrylate group or acrylate group, or (ii) a dicarboxylic acid salt comprising 2-hydroxyethyl methacrylate phthalate.

18. A composite material layer according to claim 17 wherein the polymerisable vinyl ester prepolymer has the structure

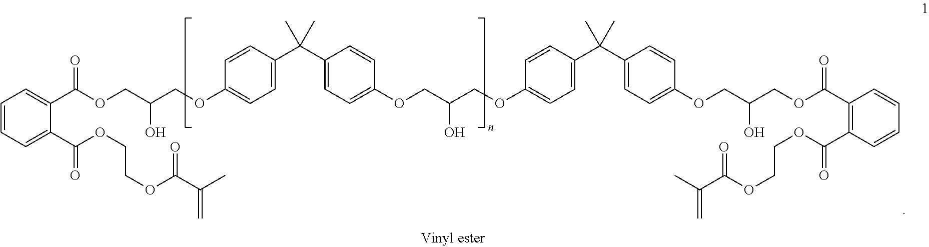

19. A composite material layer according to claim 1 wherein the curable resin has a reaction onset temperature within the range of from 85 to 95° C., as measured by dynamic scanning calorimetry (DSC) over a temperature range of from 25 to 260° C. at a ramp rate of 10° C./minute, and/or the curable resin has a gel time of from 15 to 45 minutes, measured at a temperature of 70° C.

20. A composite material layer according to claim 1 wherein the free-radical curing system exhibits a peak exotherm temperature of from 100 to 110° C., when evaluated via differential scanning calorimetry (DSC) to cure a model polymerisable resin consisting of 2-hydroxyethyl methacrylate, having CAS number: 868-77-9 containing 4-methoxyphenol at a concentration of 200 ppm by weight, wherein the DSC is carried out dynamically over a temperature range of from 25 to 260° C. at a ramp rate of 10° C./min and under a nitrogen environment, using a total weight of the 2-hydroxyethyl methacrylate and the free-radical curing system being within the range of from 8 to 16 mg, wherein for the DSC evaluation the free-radical curing system comprises at least one peroxide curing agent which is present in a total peroxide curing agent concentration of from 0.1 to 3 parts per hundred based on the weight of the 2-hydroxyethyl methacrylate.

21. A composite material layer according to claim 1 wherein the curable resin has a minimum viscosity within a temperature range of from 65 to 100° C., measured by dynamic oscillatory measurement, 2° C./min, 40 to −15° C. and a displacement of 0.0001 radians by dynamic oscillatory measurement using a 20 mm steel parallel plate geometry with a gap setting of 1000 μm.

22. A composite material layer according to claim 1 wherein the at least one polymerisable vinyl ester prepolymer, in the absence of any curing system for polymerizing the polymerisable vinyl ester prepolymer, has a viscosity within the range of 30 to 100 Poise at a temperature of 85° C., measured using a CAP viscometer from AMETEK Brookfield at a shear rate of 0.5-12 s⁻¹.

23. A composite material layer according to claim 1 wherein the curable resin is free of any particulate filler and/or free of any solvent for the at least one polymerisable vinyl ester prepolymer, and/or the curable resin consists of the at least one polymerisable vinyl ester prepolymer and the free-radical curing system for polymerizing the polymerisable vinyl ester prepolymer.

24. A composite material layer according to claim 1 wherein the composite material layer comprises a prepreg comprising at least one ply of fibrous reinforcement material which is at least partly impregnated by the curable resin, and wherein the prepreg comprises a ply of the curable resin laminated to a ply of fibrous reinforcement material whereby an exterior surface of the prepreg is formed by the ply of the curable resin.

25. A composite material layer according to claim 24 wherein the prepreg comprising a plurality of plies of fibrous reinforcement material and a plurality of plies of the curable resin, wherein the plies of fibrous reinforcement material and the plies of the curable resin are laminated together in an alternating arrangement.

26. A method of manufacturing a sandwich panel, the method comprising the steps of:
i. providing a core layer having opposite faces;
ii. positioning a respective composite material layer according to claim 24, which comprises a prepreg, adjacent to each of the opposite faces of the core layer to form a laminate comprising the core layer between opposite composite material layers;
iii. increasing the temperature of the laminate to an elevated temperature to cause the curable resin to melt and flow into the fibrous reinforcement material thereby to wet-out the fibres in the fibrous reinforcement material and to wet-out the faces of the core layer; and
iv. polymerising the prepolymer at a curing temperature which is at least as high as the elevated temperature to form, from each composite material layer, a cured resin matrix containing the fibrous reinforcement material which is bonded to a respective face of the core layer, thereby forming the sandwich panel.

27. A composite material layer according to claim 1 wherein the resin film is a coherent layer having first and second opposed resin surfaces, optionally which are self-adhesive, or wherein the resin film has first and second opposed resin surfaces and is supported on a lightweight textile sheet to which the first opposed resin surface is adhered.

28. A composite material layer according to claim 1 wherein the lightweight textile sheet has an areal weight of from 1 to 75 grams per square metre (gsm), or from 5 to 25 grams per square metre (gsm), and a tear strength of at least 500 N/m, and comprises woven or non-woven polymeric fibres.

29. A method of manufacturing a sandwich panel, the method comprising the steps of:
i. providing a plurality of layers of a fibrous reinforcement material, and a core layer having opposite faces;
ii. positioning a respective composite material layer according to claim 27 adjacent to each of the opposite faces of the core layer, and positioning a respective layer of fibrous reinforcement material over each composite material layer to form a laminate comprising the core layer between opposite composite material layers, each composite material layer being covered by a respective layer of fibrous reinforcement material;
iii. increasing the temperature of the laminate to an elevated temperature to cause the curable resin to melt and flow into the layer of fibrous reinforcement material thereby to wet-out the fibres in the fibrous reinforcement material and to wet-out the faces of the core layer; and
iv. polymerising the prepolymer at a curing temperature which is at least as high as the elevated temperature to form, from each composite material layer and layer of fibrous reinforcement material covering the composite material layer, a cured resin matrix containing the fibrous reinforcement material which is bonded to a respective face of the core layer, thereby forming the sandwich panel.

30. A method according to claim 26 wherein the cured resin matrix containing the fibrous reinforcement material is formed during the moulding of a wind turbine blade or a marine vessel.

31. A method of manufacturing a composite material layer according to claim 1, the method comprising the steps of:
i. providing a curable resin, wherein at least 50 wt % of the curable resin comprises at least one polymerisable vinyl ester prepolymer having at least two carbon-carbon unsaturated functional groups, the prepolymer being polymerisable by reaction of the unsaturated functional groups to form a cured resin, wherein the curable resin further comprises a free-radical curing system for polymerizing the polymerisable vinyl ester prepolymer, wherein the curable resin has a reaction onset temperature within the range of from 80 to 100° C., as measured by dynamic scanning calorimetry (DSC) over a temperature range of from 25 to 260° C. at a ramp rate of 10° C./minute, and the curable resin has a gel time of from 10 to 60 minutes, measured at a temperature of 70° C.;
ii. forming the composite material layer from the curable resin by either (a) prepregging the curable resin to form a prepreg comprising at least one ply of fibrous reinforcement material which is at least partly impregnated by the curable resin, wherein the prepregging step is carried out at a temperature within the range of from 60 to 70° C. and, after cooling the prepreg, the curable resin is in the form of a solid layer which is solid at 20° C., or (b) filming the curable resin to form a film of the curable resin, wherein the filming step is carried out at a temperature within the range of from 60 to 70° C. and, after cooling the film, the curable resin is in the form of a solid layer which is solid at 20° C.
